(19) United States
(12) Patent Application Publication
(10) Pub. No.: US 2013/0081331 A1
(43) Pub. Date: Apr. 4, 2013

(54) HINGED-LATCH

(71) Applicant: Peter Vullings, Palmerston North (NZ)

(72) Inventor: Peter Vullings, Palmerston North (NZ)

(73) Assignee: Empire Technology Development LLC, Wilmington (US)

(21) Appl. No.: 13/504,437

(22) PCT Filed: Sep. 29, 2011
(86) PCT No.: PCT/US11/54022

§ 371 Date: Apr. 26, 2012

(51) Int. Cl. E06B 3/32; E05D 7/00

(52) U.S. Cl. CPC E06B 3/32; E05D 7/00
USPC 49/388; 16/231; 49/506

(57) ABSTRACT

Described herein is a hinge and latch system that can be employed as a hinge, a latch, or both a hinge and a latch.

### TECHNICAL FIELD

The relevant technology generally relates to opening and closing type devices.

### BACKGROUND

A variety of hinge, latch, and hinge and latch devices exist that can be used to allow for the opening and/or closing of doors and other pivoting and/or latch type devices. Some such devices only allow for the door or other pivoting device to only be opened in a single direction. Other devices allow for the door or other pivoting device to be operated in two different directions.

### SUMMARY

In some embodiments, a hinged-latch is provided. The hinged-latch can include a pivot member. The pivot member can include a first surface and a raised disc located on the first surface. The hinged-latch can also include a receiving member. The receiving member can include a second surface configured to meet the first surface when the pivot member and receiving member are engaged and a pivot space. The pivot space can be configured to receive the raised disc and allow the raised disc to pivot within the pivot space. The receiving member can also include a disc-slot located within the second surface. The disc-slot can be configured to guide the raised disc to the pivot space. The hinged-latch can also include a key-hole located in either the pivot member or the receiving member and an actuatable key. The actuatable key can be configured to engage the key-hole and allow rotation of the pivot member relative to the receiving member when engaged with the key-hole. In some embodiments, if the actuatable key is located in the pivot member then the key-hole can be located in the receiving member. In some embodiments, if the actuatable key is located in the receiving member then the key-hole can be located in the pivot member.

In some embodiments, a method for operating a hinged-latch is provided. The method can include providing a first hinged-latch. The hinged-latch can include a pivot member that can include a first surface and a raised disc located on the first surface. The hinged-latch can also include a receiving member that can include a second surface configured to meet the first surface when the pivot member and receiving member are engaged. The receiving member can include a pivot space. The pivot space can be configured to receive the raised disc and allow the raised disc to pivot within the pivot space. In some embodiments, the hinged-latch can also include a disc-slot located within the second surface; the disc-slot can be configured to allow the raised disc to pass to the pivot space. The hinged-latch can also include a key-hole located in either the pivot member or the receiving member and an actuatable key that can be engaged with the key-hole and configured to allow rotation of the pivot member relative to the receiving member when engaged with the key-hole. In some embodiments, if the actuatable key is located in the pivot member then the key-hole can be located in the receiving member. In some embodiments, if the actuatable key is located in the receiving member then the key-hole can be located in the pivot member. The method can further include actuating the actuatable key in a first direction and removing the raised disc from the pivot space, replacing the raised disc into the pivot space, and engaging the actuatable key with the key-hole.

In some embodiments, a method for opening a door is provided. The method can include providing a door having at least a first hinged-latch, a second hinged-latch, a third hinged-latch, and a fourth hinged-latch. The first hinged-latch can be located on a top of the door and the second hinged-latch can be located on a bottom of the door, and can be substantially beneath the first hinged-latch. The third hinged-latch can be located on the top of the door and the fourth hinged-latch can be located on the bottom of the door, and can be substantially beneath the third hinged-latch. The method can also include actuating a key in the first hinged-latch and withdrawing a first raised disc from a first pivot space in the first hinged-latch. The method can also include actuating a key in the second hinged-latch to withdraw a second raised disc from a second pivot space in the second hinged-latch, and pivoting the door about a key in the third hinged-latch and a key in the fourth hinged-latch to thereby open the door.

In some embodiments, a dual swing door is provided. The dual swing door can include a door, a first hinged-latch including a first actuatable key and a second hinged-latch including a second actuatable key. The first and second hinged-latches can be connected to the door. In some embodiments, the first and second hinged latches form a first pivot line about which the door can pivot. The door can further include a third hinged-latch including a third actuatable key and a fourth hinged-latch including a fourth actuatable key. The third and fourth hinged-latches can be connected to the door. The third and fourth hinged latches can form a second pivot line about which the door can pivot.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE FIGURES

FIG. 1A is a depiction of a top view, side view, and bottom view of an illustrative embodiment of a pivot member.

FIG. 1B is a depiction of a top view, side view, and bottom view of an illustrative embodiment of a receiving member.

FIG. 1C is a depiction of a side view of an illustrative embodiment of a pivot member.

FIG. 1D is a depiction of a perspective view of an illustrative embodiment of a pivot member.

FIG. 1E is a depiction of a perspective view of an illustrative embodiment of a receiving member.

FIG. 2A is a depiction of some embodiments of an electrical track in a first orientation.

FIG. 2B is a depiction of some embodiments of an electrical track in a second orientation.

FIG. 2C is a depiction of some embodiments of an electrical track in a third orientation.

FIG. 3A is a depiction of a side view of some embodiments of a hinged-latch having an actuatable key in an engaged position.

FIG. 3B is a depiction of a side view of some embodiments of a hinged-latch having an actuatable key in a retracted or disengaged position.

FIG. 4A is a depiction of a side view of some embodiments of a hinged-latch having an actuatable key in a disengaged position.

FIG. 4B is a depiction of a side view of some embodiments of a hinged-latch having an actuatable key in an engaged position.

FIG. 5A is a depiction of a side view of some embodiments of a hinged-latch and handle arrangement having an actuatable key in an engaged position.

FIG. 5B is a depiction of a side view of some embodiments of a hinged-latch and handle arrangement having an actuatable key in a retracted or disengaged position.

FIG. 6 is a depiction of a front view of some embodiments of a framed door employing four hinged-latches.

### DETAILED DESCRIPTION

Frequently, doors (and other pivoting structures) are designed with a hinge at one side which allows them to swing open from that side. This can be described as the ‘handedness’ of the door (e.g., right-handed or left-handed). Home design, work space design, and living space design (for example) can be compromised because this limited handedness of the open door can hinder the operation of other doors or equipment.

Provided herein are various hinged-latch devices that can be employed as a hinge and/or pivot system and/or a latch. In some embodiments, the device can serve as both the hinge and/or the latch unit. In some embodiments, the hinged-latch can be installed on all four corners of a door, and can allow the door to then swing open from either side and latch from the appropriate opposing side.

In some embodiments, the hinged-latch includes an actuatable key. In some embodiments, the actuatable key allows for the hinged-latch to operate securely and/or selectively as a hinge, latch, and/or hinged-latch.

The following description outlines the basic parts of various embodiments of the hinged-latch in more detail and with respect to the figures, it then describes various specific variations and embodiments for various parts of the device and methods.

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented herein. It will be readily understood that the aspects of the present disclosure, as generally described herein, and illustrated in the Figures, can be arranged, substituted, combined, separated, and designed in a wide variety of different configurations, all of which are explicitly contemplated herein.

### Hinged-Latch

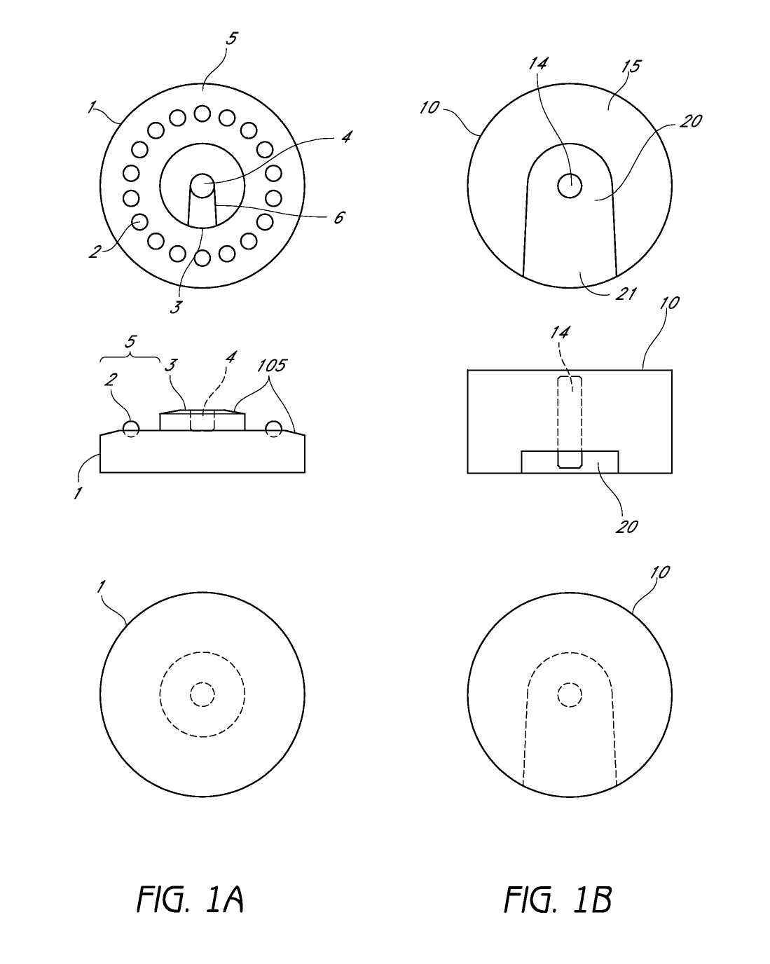

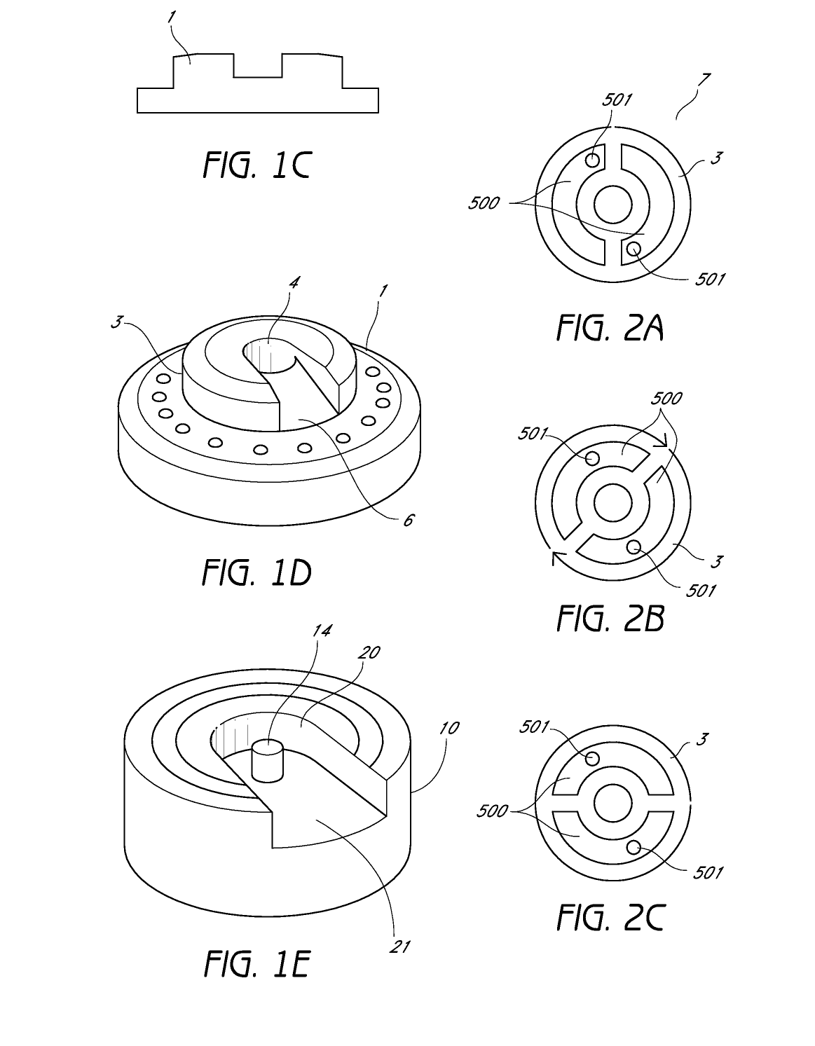

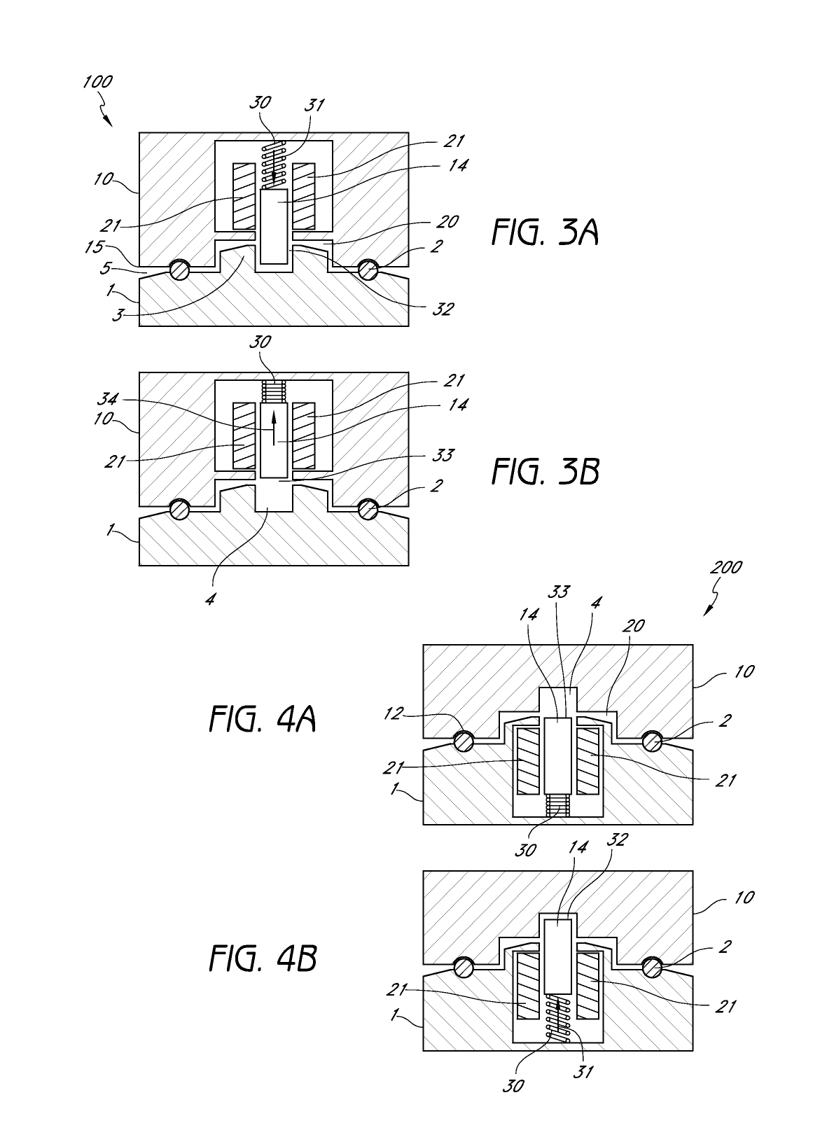

In some embodiments, a hinged-latch is provided. The hinged-latch can include a pivot member 1 (as shown in FIG. 1A). The pivot member can include a first surface 5 and a raised disc 3 located on the first surface. In some embodiments, the hinged-latch can also include a receiving member 10 (FIG. 1B). The receiving member 10 can include a second surface 15, that can be configured to meet the first surface 5 when the pivot member 1 and the receiving member 10 are engaged (examples of engaged hinged-latches are shown in FIGS. 3A-4B).

In some embodiments, as shown in FIG. 1B, the receiving member 10 can further include a pivot space 20, that can be configured to receive the raised disc 3 and allow the raised disc 3 to pivot within the pivot space. In some embodiments, the receiving member 10 can further include a disc-slot 21 located within the second surface 15 of the receiving member 10. In some embodiments, the disc-slot 21 can be configured to guide and/or allow the raised disc 3 into the pivot space 20.

In some embodiments, the hinged-latch of FIG. 1A and FIG. 1B can further include a key-hole 4 located in either the pivot member 1 (depicted) or the receiving member 10 (not depicted). In some embodiments, the hinged-latch can further include an actuatable key 14. In some embodiments, the actuatable key 14 can be configured to engage the key-hole 4 while still allowing rotation of the pivot member 1 relative to the receiving member 10 when engaged with the key-hole 4.

As shown in FIG. 1B, the actuatable key 14 can be part of the receiving member 10. In some embodiments, the actuatable key 14 can be part of the pivot member 1. In some embodiments, when the actuatable key 14 is located in the pivot member 1, the key-hole 4 located in the receiving member 10. In some embodiments, when the actuatable key 14 is located in the receiving member 10, then the key-hole 4 is located in the pivot member 1 (as shown in FIGS. 1A and 1B).

In some embodiments, the first surface 1 includes a low coefficient of friction surface. In some embodiments, the second surface 15 includes a low coefficient of friction surface. In some embodiments, first surface 5 includes at least one ball bearing 2. In some embodiments the second surface 15 includes a bearing race (not shown). In some embodiments, the second surface 15 includes at least one ball bearing (not shown). In some embodiments, the first surface 5 and the second surface 15 are configured to allow easy and/or low friction rotation between the two surfaces when the pivot member 1 is engaged with the receiving member 10.

In some embodiments, the key-hole 4 can be located in the pivot member 1. In some embodiments, the key-hole 4 can be located in about the center of the raised disc 3. In some embodiments, the key-hole 4 can be located in the receiving member 10 (not shown). In some embodiments, the key-hole 5 can be located in about the center of the pivot space 20 (not shown). In some embodiments, the raised disc can be approximately circular. In some embodiments, the raised disc can be any shape (and need not be circular), as long as it allows for adequate support and rotation ability when engaged with the receiving member. Thus, in some embodiments, the raised “disc” can be triangular, square, rounded, etc, as long as, when it is engaged, it allows for rotation within the pivot space.

In some embodiments, rather than rotation occurring within the pivot space 20, the pivot space can be configured to lock or restrain the raised disc. In such embodiments, the pivot member 1, the receiving member 10, or both the pivot member and the receiving member can instead be pivotable with respect to the door, frame, or other surface in which they are placed. For example, the member can be positioned on top of a lazy susan type ball bearing system, or encased within an outer casing that allows for the rotation of the member. In some embodiments, the pivot member and/or receiving member are aligned when the user wishes to open the door (e.g., disengage the hinge). In some embodiments, as long as the members return to a position where this is possible, then the device can function.

In some embodiments, the actuatable key 14 can be located in the pivot member 1, (not shown). In some embodiments, the actuatable key 14 can be located in about the center of the raised disc 3 (not shown). In some embodiments, the key-hole 4 can be located in the receiving member 10. In some embodiments, the actuatable key 14 can be located in the receiving member 10. In some embodiments, the actuatable key 14 can be located in the about center of the pivot space 20. In some embodiments, the key-hole 4 can be located in the pivot member 1.

In some embodiments, the actuatable key can be electrically actuatable. In some embodiments, the actuatable key includes a solenoid. In some embodiments, the device further includes a spring 30 (see, e.g., FIGS. 3A, 3B, 4A, and 4B) configured to urge the actuatable key outward from the pivot member or the receiving member.

In some embodiments, the hinged-latch further includes a ramp 6 positioned to urge the actuatable key into the key-hole (FIGS. 1A and 1D). In embodiments in which the actuatable key 4 is moved outward when the receiving member 1 and the pivot member 10 are disengaged, the ramp 6 can assist in urging the actuatable key 14 into the key-hole 4.

In some embodiments, the pivot member 1 can be or include at least one of plastic, metal, ceramic, timber, or any combination thereof. In some embodiments, the receiving member 10 can be or include at least one of plastic, metal, ceramic, timber, or any combination thereof.

In some embodiments, the raised disc 3 can be at least partially chamfered 105 (e.g., FIGS. 1A and 1D). In some embodiments, the pivot member 1 can be approximately circular. In some embodiments, the receiving member 10 can be approximately circular. In some embodiments, the pivot member 1, the receiving member 10, or both, are sized and/or configured to be placed in a door or a door frame. In some embodiments, the door can be a cabinet door, kitchen cabinet door, front door, closet door, cupboard door, pantry door, wardrobe door, garage door, driveway gate, refrigerator door, etc. In some embodiments, the door or use can be for kitchen storage spaces (cupboards, pantries); Interior storage solutions (cupboards, wardrobes); interior doors; doors and storage in confined spaces (apartments, caravans, campers, aircraft, trains and other vehicles); and doors and storage for accessibility (disabled people, elderly people).

In some embodiments, an outer surface of the pivot member, an outer surface of the receiving member, or both, can be threaded so as to allow ease of insertion into a hole in a door and/or frame.

In some embodiments, the pivot space 20 includes a circular wall in the receiving member 10. In some embodiments, the pivot space 20 can be beneath or recessed in the second surface 15. In some embodiments, a top surface of the raised disc 3 and a surface of the pivot space 20 do not contact each other when the pivot member 1 is engaged with the receiving member 10. In some embodiments, the top surface of the raised disc 3 and the surface of the pivot space 20 do contact each other when the pivot member 1 is engaged with the receiving member 10. In some embodiments, the top surface of the raised disc 3 and the surface of the pivot space 20 are or include a low or reduced coefficient of friction surface.

In some embodiments, at least a portion of the actuatable key 14 can be generally cylindrical. In some embodiments, at least a portion of the key-hole 4 can be generally cylindrical. In some embodiments, the actuatable key 14 can be sized and shaped so as to allow the actuatable key to engage the key-hole 4 to an adequate degree so as to allow a solid connection to form between the pivot member 1 and the receiving member 10 (e.g., FIGS. 3A and 4B). In some embodiments, additional or all of the load bearing support can be provided by the interaction between the raised disc 1 and the walls of the pivot space 10. In some embodiments, the actuatable key 14 serves as a safety feature to avoid or reduce the chances of an inadvertently disengaging the raised disc 3 from the pivot space 20 and separating the pivot member 1 from the receiving member 10. Thus, in some embodiments, the key 14 and key-hole 14 interaction need not support the weight or movement of a door, but can instead simply be adequate to reduce or prevent the lateral disengagement of the pivot member 1 from the receiving member 10 (with or without the additional support of the raised disc and pivot space interaction noted below). In some embodiments, the first surface 5 and second surface 15 take at least some if not more of the load applied to the hinge when in use. Thus, in some embodiments, the raised disc 3 and the pivot space 20 interaction need not support the weight or movement of a door, but can instead simply be adequate to reduce or prevent the lateral disengagement of the pivot member 1 from the receiving member 10 (with or without the additional support of the key and key-hole interaction noted above). In some embodiments, the first and second surfaces receive at least 0.1, 1, 2, 3, 4, 5, 10, 15, 20, 25, 30, 40, 50, 60, 70, 80, 85, 90, 95, 96, 97, 98, 99, 99.9, or 99.99 percent of the weight and/or force applied to the device when the device is used in a door and frame arrangement, include any range defined between any two of the preceding values, and any range above any one of the preceding values. In some embodiments, the raised disc and pivot space receive at least 0.1, 1, 2, 3, 4, 5, 10, 15, 20, 25, 30, 40, 50, 60, 70, 80, 85, 90, 95, 96, 97, 98, 99, 99.9, or 99.99 percent of the weight and/or force applied to the device when the device is used in a door and frame arrangement, include any range defined between any two of the preceding values, any range below any one of the preceding values, and any range above any one of the preceding values.

While not required in all embodiments, in some embodiments, the hinged-latch can include one or more spring 30. In some embodiments, the spring 30 (e.g., FIG. 3A) can be configured to urge the actuatable key 14 in a direction 31 to a first position 32. When this position is the same position in which the actuatable key 14 would be in the key-hole 4, the position can be denoted as the “engaged” position. The actuatable key 4 need not actually be in the keyhole 14 in order for the actuatable key to be in the “engaged position” 32, as the term merely denotes the location of the actuatable key itself. Of course, if the actuatable key 4 is engaged with the key-hole 14, then the term denotes that the actuatable key is within the keyhole itself. In some embodiments, actuation of the actuatable key 14 urges the actuatable key in a second direction 34 to a second position 33 (FIG. 3B). In some embodiments, the first direction can be substantially opposite to the second direction. The second position 33 in FIG. 3B can be denoted as the disengaged position for the actuatable key 14.

In some embodiments, the first position 32 can be one in which the actuatable key 14, as part of the receiving member 10, can be engaged with the actuatable key-hole 4 (e.g., FIG. 3A). In some embodiments, the second position 33 can be one in which the actuatable key 14, as part of the receiving member 10, can be withdrawn from the actuatable key-hole 4 (e.g., FIG. 3B).

In some embodiments, the first position 32 can be one in which the actuatable key 14, as part of the pivot member 1, can be engaged with the actuatable key-hole 4 (e.g., FIG. 4A). In some embodiments, the second position 33 can be one in which the actuatable key 14, as part of the pivot member 1, can be withdrawn from the actuatable key-hole 4 (e.g., FIG. 4B).

In some embodiments, when engaged, the pivot member 1 and the receiving member 10 can assist in securing a load of a door. In some embodiments, the pivot member 1 and the receiving member 10 can assist in securing a load of a door, when the door is open. In some embodiments, when engaged, the pivot member 1 and the receiving member 10, the first surface 5, and the second surface 10, the actuatable key 14 and the key-hole 4, or any combination thereof can support, for example, 5 kg on an opposing end of a door, when the door is open. For example, the load can be 5, 10, 15, 20, 30, 40, 50, 70, 90, 100, 200, 300, 500, 1000 kg or more, including any range between any two of the preceding values and any range below or above any two of the preceding values. Thus in some embodiments, the pivot member 1 and/or receiving member 10 can be configured and/or composed of a material adequate to support such a load and/or the movement of a such a load.

In some embodiments, a method for operating the hinged-latch is provided. In some embodiments, the method can include providing the first hinged-latch 100, FIG. 3A. The hinged-latch can include a pivot member 1. The member can include the first surface 5 and the raised disc 3 located on the first surface. The hinged-latch can also include the receiving member 10. The receiving member 10 can include the second surface 15 configured to meet the first surface 5 when the pivot member and receiving member are engaged (as shown in FIG. 3A). The receiving member can also include the pivot space 20. The pivot space can be configured to receive the raised disc 3 and allow the raised disc to pivot within the pivot space. The receiving member can also include the disc-slot located within the second surface and configured to allow the raised disc to pass to the pivot space. The hinged-latch can also include the key-hole 4 located in either the pivot member (FIG. 3A) or the receiving member (FIG. 4A). In some embodiments, the hinged-latch can include the actuatable key 14.

In some embodiments, the actuatable key 14 can be or is engaged with the key-hole (as shown in FIGS. 3A and 4B). In some embodiments, the actuatable key 14 can be configured to allow rotation of the pivot member 1 relative to the receiving member 10 when engaged with the key-hole 4 (FIGS. 3A and 4B). In some embodiments, when the actuatable key 14 is located in the pivot member 1 then the key-hole 4 can be located in the receiving member 10. In some embodiments, when the actuatable key 14 is located in the receiving member 10 then the key-hole 4 can be located in the pivot member 1.

In some embodiments, the method further includes actuating the actuatable key in the direction 34 and removing the raised disc 3 from the pivot space 20 (see, e.g., FIGS. 3B and 4A). In some embodiments, the method further includes replacing the raised disc 3 into the pivot space 20, and engaging the actuatable key 14 with the key-hole 4 (e.g., FIGS. 3A and 4B).

In some embodiments, engaging the actuatable key 14 with the key-hole 4 includes actuating the actuatable key in the direction 31 that can be substantially opposite to the direction 34. In some embodiments, engaging the actuatable key 14 with the key-hole 4 includes removing an electrical potential. In some embodiments, the electrical potential can be a force that actuated the actuatable key in the direction 34. In some embodiments, the method includes providing a spring force to urge the actuatable key 14 in a direction 31, wherein the direction can be substantially opposite to the direction 34. In some embodiments, engaging the actuatable key 14 with the key-hole 4 includes applying an electrical potential.

In some embodiments, the actuatable key 14 can be mechanically actuatable. In some embodiments, one or more hinged-latches (1, 10) can be mechanically linked 51 and 52 to one or more switches, handles, or other mechanically actuatable devices. Any linking mechanism can serve (e.g., cable, chain, rod, push rod, plate, tense spring, etc.), as long as it allows force to be transmitted or altered at the hinged-latch. In some embodiments, switching the switch or other mechanically actuatable device can allow for actuation or deactuation of the actuatable key.

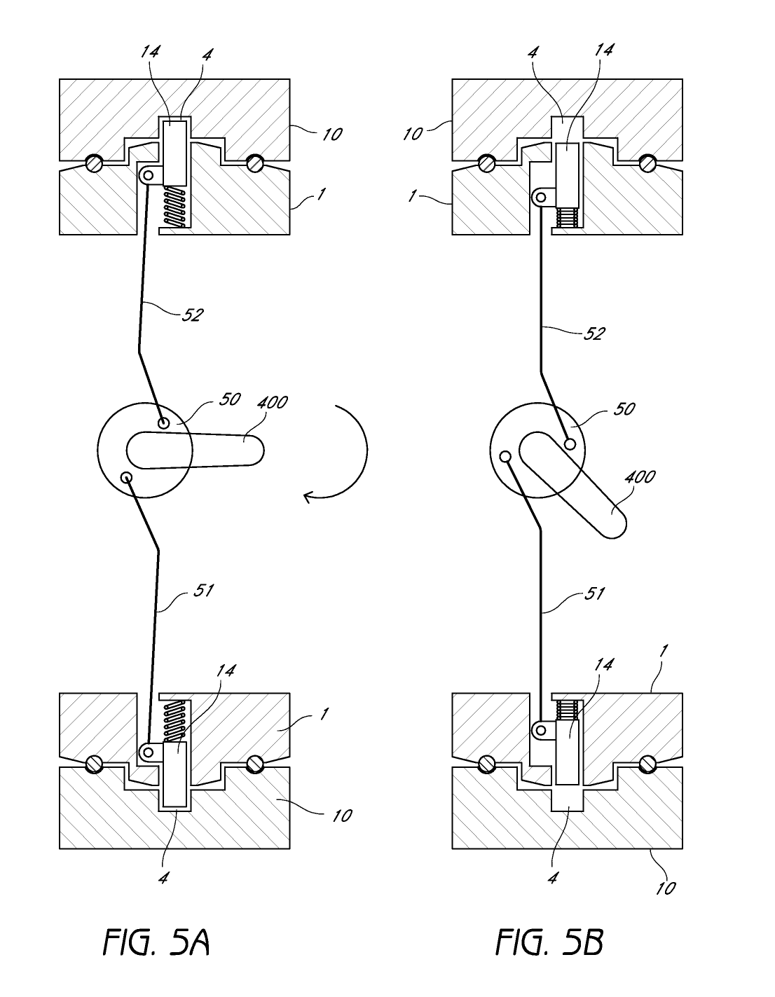

In some embodiments, the actuation of the actuatable key 14 can be linked with a desired opening and closing action of a door associated with the hinged-latches. In some embodiments, this can be achieved by placing the switch or other command console next to a handle on the door. In some embodiments, this can be done by combining the handle with the switch itself. For example, as shown in FIG. 5A, when the handle 400 is in a resting state, the actuatable keys 14 can be in their engaged position, allowing the hinged-latches to stay engaged and serve either as a latch and/or a hinge. As shown in FIG. 5B, actuation of the handle 400 can disengage the actuatable key 14, allowing the hinged latch to separate and/or swing open. In some embodiments, the mechanical link 51 and 52 can be straight. In some embodiments, the mechanical link 51 and 52 can be kinked, curved, or angled. In some embodiments, the handle 400 can be attached to a rotating member 50, such as a disc, which can be connected to the mechanical links 51 and 52.

In some embodiments, there can be one or more handle and/or switch for each hinged-latch. In some embodiments, there can be one or more handle and/or switch for each pair of hinged latches (and the handle and/or switch can operate one or both of the pair). In some embodiments, actuating the handle results in disengaging the actuatable key. In some embodiments, actuating the handle results in engaging the actuatable key. In some embodiments, the device includes one or more springs (leaf, coiled, etc) such that release of the handle will result in the actuatable key being extended back to the position it is in when engaged, even if the pivot member is not engaged with the receiving member. In some embodiments, for the latching aspect to happen by default. In some embodiments, the device can be configured such that the actuatable key remains in its disengaged position until the pivot member and receiving member are once again fully engaged (which can be useful to reduce stress on the actuatable key, for example). In some embodiments, the handle can be spring loaded, so that it returns to its original position when released. In some embodiments, the return of the handle and/or switch to its previous position can force the key back to its previous state. In some embodiments, the pivot member and/or receiving member need not include a spring.

In some embodiments, the actuatable key can be actuated (and/or deactuated) by electricity. In some embodiments, the actuatable key can include a solenoid, although it is not limited to such an arrangement. In some embodiments, the actuatable key can include a motor and screw combination so that the actuatable key is screwed upwards or downwards upon the operation of the motor. In some embodiments the actuatable key can be dynamic itself, such as a memory metal, and electricity and/or heat applied to the key can actuate the key. In some embodiments, actuation can include actuating by inserting a tool (e.g. a screwdriver or door key), and/or by magnetic force by applying a magnet to the outside of the door which actuates the key (e.g., directly, or by releasing a physical switch and/or electrical switch which then allows the key to actuate). In some embodiments, pneumatic and/or hydraulic pressure can be used, including the appropriate machinery for such aspects.

As shown in FIGS. 2A-2C, in some embodiments (such as some of the embodiments that employ an electrical current), the hinged-latch further includes an electrical track 500 on a surface of the raised disc 3. In some embodiments, the electrical track 500 is configured so as to allow current to flow when the disc is in a first orientation (FIG. 2A) as well as when the disc is rotated to a second orientation (e.g., FIGS. 2B and 2C). In some embodiments, the receiving member can include a contact portion(s) 501 that can maintain electrical communication between the disc 3 and the receiving member 10, in various orientations of the disc. As such, in some embodiments, rotation of the raised disc 3 need not break an electrical circuit that can otherwise include the hinged-latch, when the hinged-latch is acting as a hinge. Thus, in some embodiments, regardless of the relative orientation of the pivot member 1 and the receiving member 10, in some embodiments a current can still flow through these hinged latches, when operated as hinges. In some embodiments (such as the door embodiments described below), this can allow for one set of hinged-latches to not only serve as a hinge, but also serve as an electrical conduit when serving as a hinge, not only for that particular set of hinged latches, but also for the set of hinged-latches serving as the latch (assuming that they are in electrical communication with the other set).

### Door and Method for Operation

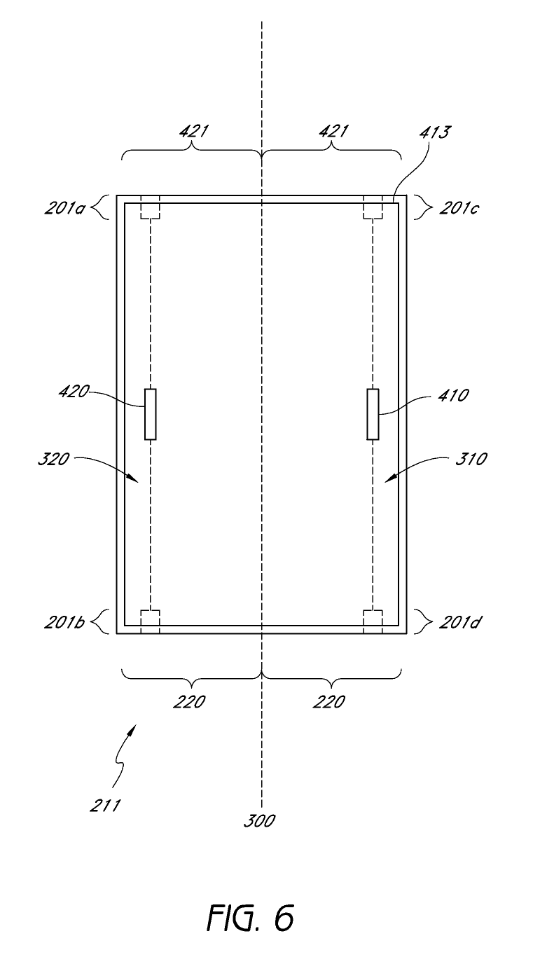

FIG. 6 depicts some embodiments employing four hinged-latches 201a, 201b, 201c, and 201d on a door 413, including a first handle 420 and a second handle 410. In some embodiments, the handle(s) are optional. In some embodiments, the door 413 has no handle. In some embodiments, the door 413 can be, for example, electrically actuated, and can be opened and/or closed by pushing directly on the door (or even the open/close movement may be facilitated by a motor, spring, hydraulics etc). In some embodiments, the door 413 can be opened completely by electricity and/or electrically driven motors or devices.

In some embodiments, the hinged-latch 201 can be placed on the corners of doors (e.g., as shown in FIG. 6). In some embodiments, a first pair of hinged-latches 201a and 201b can be positioned on a first side of a door 413, to one side of the center 300 of the door. A second pair of hinged-latches 201c and 201d can be positioned in a second side of the door 413, to the other side of the center 300 of the door. In some embodiments, the pairs of hinged-latches (as well as the pivot lines) can be positioned anywhere within in the first half of the door 220, for the first pair of hinged-latches 201a and 201b, and the handle 410 can be positioned anywhere within a section 411 on the door. In some embodiments, the pairs of hinged-latches (as well as the pivot lines) can be positioned anywhere within in the second half of the door 210, for the second pair of hinged-latches 201c and 201d, and the handle 420 can be positioned anywhere within a section 421 on the door. As will be appreciated by those of skill in the art, in light of the present disclosure, positioning the handles 420, and 410 distal to the center, and/or positioning the hinged-latches 201a, 201b, 201c, and 201d distal to the center 300 will allow for greater easy of opening the door in either or both of the directions. As will be appreciated by those of skill in the art, in light of the present disclosure, positioning the pairs of hinged-latches closer to the center will move the corresponding pivot line closer to the center of the door. In some embodiments, an apparatus is provided that includes a frame, a door configured to fit within the frame, and a set of hinged-latches, pivotably associating the door to the frame. In some embodiments, one or more of the hinged-latches includes any of the hinged-latches described herein. In some embodiments, the door can be associated with the frame by two hinged-latches. In some embodiments, the door can be associated with the frame by a first hinged-latch, a second hinged-latch, a third hinged-latch, and a fourth hinged-latch. In some embodiments, the door includes a topside and a bottom side. The first hinged-latch attaches the door to the frame at the topside of the door. The second hinged-latch attaches the door to the frame at the bottom side of the door. The third hinged-latch attaches the door to the frame at the topside of the door. The fourth hinged-latch attaches the door to the frame at the bottom side of the door.

In some embodiments, a dual swing door is provided and can include the door 413, the first hinged-latch 201a that includes the first actuatable key 14 and a second hinged-latch 201b that includes a second actuatable key 14. In some embodiments, the first and the second hinged-latches are connected to the door 413. The first and the second hinged latches (201a and 201b) form the first pivot line 320 about which the door can pivot. In some embodiments, the third hinged-latch 201c can be included having a third actuatable key and the fourth hinged-latch 201d including a fourth actuatable key can be included. In some embodiments, the third and the fourth hinged-latches are connected to the door 413, and the third and the fourth hinged latches form the second pivot 310 line about which the door 413 can pivot.

In some embodiments, the dual swing door further includes a door frame 211 which at least partially surrounds the door. In some embodiments, the dual swing door 413 further includes at least the first door handle 420. In some embodiments, the first door handle 420 can be mechanically engaged with the first and the second hinged-latches (201a, 201b) such that manipulating the first door handle 420 actuates the actuatable keys in the first and second hinge-latches (201a and 201b) and allows the door to pivot about the third and fourth hinged latches.

In some embodiments, the door 413 further includes the second handle 410. In some embodiments, the second handle 410 can be mechanically engaged with the third and fourth hinged-latches (201c and 201d) such that manipulating the second handle actuates the actuatable keys in the third and the fourth hinge-latches and allows the door to pivot about the first and the second hinged latches (201a and 201b).

In some embodiments, the first door handle 420 can be in electrical communication with the first and the second hinged-latches (201a and 201b), such that manipulating the handle actuates the actuatable keys in the first and the second hinge-latches and allows the door 413 to pivot about the third and the fourth hinged latches (201c and 201d). In some embodiments, an electrical circuit can be present in the door, via electrical contact in the hinged-latches 201c and 201d, which can allow electrical control of the hinged latches 201a and 201b, even if the door is opened and there is no source of electrical power in the door or other wiring to the door. In some embodiments, the signal passing through the hinged-latches 201c and 201d to disengage the hinged latches 201a and 201b, will not open the hinged-latches 201c and 201d. In some embodiments, this result can be achieved using mechanical door handles, for example, the door handles can be connected via a rod (or some other mechanical linkage) that ‘locks’ one of the handles when the other is opened. In some embodiments, this can act as a safety to ensure that both sets of hinges are not opened at once. In some embodiments, the signal ensures that hinged-latches 201c and 201d are engaged. In some embodiments, a signal from one handle can disengage switching at the undesired set of hinged latches. In some embodiments, the electrical communication occurs through an engaged hinged-latch (such as hinged-latches 201c and 201d when they act as a hinge), and can be electrically isolated from the switching in the hinge-latch itself. Thus, in some embodiments, the contact portions 501 and the electrical tracks 500 (shown in FIGS. 2A-2C), can be configured to pass electrical current through the hinged-latch, without actuating or deactuation. In some embodiments, the contact portions 501 and the electrical tracks 500 (shown in FIGS. 2A-2C), can be configured to pass electrical current through the hinged-latch, while also allowing actuation and/or deactuation of the actuatable key. In some embodiments, the door can have an internal supply of power (such as a battery). In some embodiments, the door can be wired, allowing for power to all 4 hinged-latches even when some of the hinged-latches are open. In some embodiments, the hinged-latches can be in electrical communication with one another (e.g., 201C to 201A to 201B to 201D; 201C to 201D to 201B to 201C; 201C to 201B to 201A to 201D; 201C to 201B to 201A to 201D; etc.). In some embodiments, only pairs of the hinged-latches are in signal communication with one another, but one or more pairs can be in electrical communication with one another (e.g., so that electrical power can flow through the hinges to supply an actuating and/or deactuating signal to the separated hinged-latches).

In some embodiments, the second handle 410 can be in electrical communication with the third and the fourth hinged-latches (201c and 201d) such that manipulating the second handle actuates the actuatable keys in the third and the fourth hinge-latches and allows the door to pivot about the first and the second hinged latches (201a and 201b).

In some embodiments, a method for opening the door 413 is provided. In some embodiments, the method can include providing the door 413 having at least the first hinged-latch 201a, the second hinged-latch 201b, the third hinged-latch 201c, and the fourth hinged-latch 201d. In some embodiments, the first hinged-latch 201c can be located on a top of the door 413 and the second hinged-latch 201b can be located on a bottom of the door 413, substantially beneath the first hinged-latch 201a. In some embodiments, the third hinged-latch 201c can be located on the top of the door 413 and the fourth hinged-latch 201d can be located on the bottom of the door 413, substantially beneath the third hinged-latch 201c. In some embodiments, one can actuate the actuatable key in the first hinged-latch 201a and withdraw the first raised disc from the first pivot space in the first hinged-latch. In some embodiments, one can actuate the key in the second hinged-latch 201b to withdraw a second raised disc from the second pivot space in the second hinged-latch. In some embodiments, one can then pivot the door 413 about the actuatable key in the third hinged-latch 201c and the key in the fourth hinged-latch 201d to thereby open the door.

In some embodiments, one can further pivot the door about the actuatable key in the third hinged-latch 201c and the actuatable key in the fourth hinged-latch 201d to close the door. In some embodiments, one can further engage the actuatable key in the first hinged-latch 201a when the first raised disc is within the first pivot space in the first hinged-latch. In some embodiments, one can further engage the actuatable key in the second hinged-latch 201b when the second raised disc is within the second pivot space in the second hinged-latch. In some embodiments, one can further actuate the actuatable key in the third hinged-latch 201c and withdraw the third raised disc from the third pivot space in the third hinged-latch. In some embodiments, one can further actuate the actuatable key in the fourth hinged-latch 201d and withdraw the fourth raised disc from the fourth pivot space in the fourth hinged-latch. In some embodiments, one can further pivot the door about the actuatable key in the first hinged-latch 201a and the actuatable key in the second hinged-latch 201b to thereby open the door 413.

Line 320 (FIG. 6) displays the pivot point or line which extends through a top side of the door to the bottom side and goes from the first hinged-latch 201a to the second hinged-latch 201b. When the hinged-latches 201a and 201b function as hinges, pivot line 320 shows where the door will pivot about. In such a mode, the hinged-latches 201c and 201d function as latches (for example, can be electrically or mechanically actuated) and allow separation of the door 413 from the frame 211 on the opposite side of the door. In contrast, when the hinged-latches 201c and 201d function as hinges, pivot line 310, which extends from a top to an opposing side of the door, through both hinged-latches 201c and 201d shows where the door pivots about. In such a mode, the hinged-latches 201a and 201c function as latches (for example, can be electrically or mechanically actuated) and allow separation of the door 413 from the frame 211 on the opposite side of the door.

In some embodiments, when the door is to pivot about the first pivot line 320, the user disengages the actuatable key 14 from the keyhole 4 in the appropriate hinged-latches. In some embodiments, some force substantially perpendicular to the plane of the door (e.g., out of the plane of the figure) at, for example, at handle 410 can be applied. In some embodiments, when the door is to pivot about the second pivot line 310, the user disengages the actuatable key from the keyhole in the opposite hinged-latches.

In some embodiments, the handles can be situated along the pivot line and be vertically centered. In some embodiments, the handles are situated along the pivot line and are not vertically centered. In some embodiments, the handles are not situated along the pivot line and are vertically centered. In some embodiments, the handles are not situated along the pivot line and are not vertically centered. In some embodiments, a handle can be placed anywhere, as long as the handle is horizontally closer to one set of latches than the other. In some embodiments, the further the handle is horizontally from the opposite latches, the more efficient it will be (although as an opening force is not required in an actuated embodiment, the efficiency refers to leverage on the door). Likewise, vertical placement of the handle can be more efficient if centered, but such placement is not a requirement.

In some embodiments, the amount of force required to open or close a door involving a hinged-latch can be adjusted. As the actuatable key is actuatable, the amount of force can relate to the amount of force involved in retracting the appropriate number of actuatable keys in the corresponding number of hinged-latches. As shown in FIG. 3A, for example, in some embodiments, the hinged-latch 100 includes the spring 30 and the spring force keeps the actuatable key 14 engaged with the keyhole 4 until the device is actuated. In some embodiments, the spring force can be set according to the specific door or application, and can take into account the weight of the door and how much force it will be subjected to when in use or resting (e.g. external noise, such as wind and sources of vibrations). In some embodiments, rather than involving the spring, the actuatable key can be engaged with the keyhole by other devices or aspects. For example, in some embodiments, the actuatable key can be engaged by reversing a solenoid's direction. In some embodiments, the actuatable key can be engaged by a locking system elsewhere in the device (such as in the handle 400 (FIG. 6), a gear system, a friction based system, other switch, etc.).

In some embodiments, the door 413 (FIG. 6) can be readily installed and/or removed. In some embodiments the door can be installed by lining up the pivot members with the receiving members of all four of the hinged-latches (201a, 201b, 201c, and 201d) and pressing both sides of the door 413 into the frame 211 at once. The door 413 can likewise be removed from the frame 211 by pulling both sides of the door at once when at least some (for example half or all) of the actuatable hinged latches have the actuatable key disengaged with the key-hole. In some embodiments, as these hinged-latches can include an actuatable safety mechanism this is unlikely to occur in normal operation, unless intended.

In some embodiments, the pivot members 1 are attached to the frame 211. In other embodiments, the pivot members 1 are attached to the door 413. As shown in FIG. 6, in some embodiments, the hinged-latches can be attached to all four corners of the frame, positioned opposite of the top of the door and the bottom of the door.

In some embodiments, the weight of the door rests on the lower two hinged-latches 201b and 201d (in FIG. 6), in some such embodiments, the spring (e.g., either mechanical or an outwardly directed actuation) in these hinged-latches can be sufficiently stiff to ensure that the actuatable key is outwardly directed sufficiently to keep the key in the key-hole as desired (e.g., until actuation).

In some embodiments, a method for operating a dual pivot point door (an example of which is shown in FIG. 6) is provided. In some embodiments, the method can be applied to any of the hinged-latch embodiments described herein. In some embodiments, the method includes providing the dual pivot point door that includes providing the frame, the door configured to fit within the frame, and the set of hinged-latches, pivotably associating the door to the frame.

In some embodiments, the door can include a front surface, the first pivot line 320 extending from the first hinged-latch 201a though the door to the second hinged-latch 201b, and the second pivot line 310 extending from the third hinged-latch 201c though the door to the fourth hinged-latch 201d. The method can also include applying a first opening force perpendicularly to the front surface of the door at a position closer to the first pivot line 320 than the second pivot line 310, such that the first and the second hinged-latches 201a and 20 lb operate as latches, and such that the third and the fourth hinged-latches 201c and 201d operate as hinges and the door pivots about the second pivot line 310. In some embodiments, the method also includes applying a force opposite in direction to the first opening force (e.g., a closing force), to close the door. The method can also include applying a second opening force perpendicularly to the front surface of the door at a position closer to the second pivot line 310 than the first pivot line 320, such that the first and the second hinged-latches 201a and 201b operate as hinges, and such that the third and the fourth hinged-latches 201c and 201d operate as latches so that the door pivots about the first pivot line 320. In some embodiments, when applying the opening force, one can actuate the actuatable key in the hinged-latches that are to act as the latch, while keeping the other hinged-latch(es) unactuated (so that the other(s) can function as a hinge).

In some embodiments, the handles include an actuation component in communication with one or more of the hinged-latches so that touching or manipulating the handles will result in the desired actuated or unactuated state for the appropriate hinged latches. In some embodiments, the handle includes or is, the actuation controller. In some embodiments, the actuation controller can be separate from the handle.

In some embodiments, the actuation controller (and handle if it is part of the controller) can be locked or lockable (so that an outside key can be used to drive or activate actuation). In some embodiments, the actuation component can provide a security component to the device, as locking the hinged-latches can effectively lock a door shut.

### Additional Embodiments and Variations

For the sake of clarity and brevity, the following variations have been provided, with the understanding that these variations are contemplated as being combined and/or applied in any of the embodiments described herein.

In some embodiments, the hinged-latch can be manufactured as four separate parts that can be cast from any suitable material (including plastics, metals, or any combination thereof). In some embodiments, the fifth part includes the spring. In some embodiments, the spring of any lower hinge (that taking the weight of the door) can be stiffer than those of an upper hinges.

In some embodiments, one or more of the hinged-latches are employed. In some embodiments, two hinged-latches are employed on any one door. In some embodiments, three hinged-latches are employed on any one door, with two on one side and one on the opposing side. In some embodiments four hinged-latches are employed on each door or item to be supported. In some embodiments, the hinged-latches can be placed on four corners of the door. In some embodiments, the hinged-latches are placed away from the sides of the doors, and closer to the center of the doors. Thus, in some embodiments, the door can pivot about a point that can be set more towards the center of the door than the edge of the door. In some embodiments the hinges are positioned in the top end and the bottom end of the door, so as to allow the door to be opened to the left or opened to the right. In some embodiments, the hinges are positioned in the left end and right end of the door, so as to allow the door to be opened upwards or downwards.

In some embodiments, one or more part of the device can be made of, for example, plastic, nylon, rubber, metal, copper, brass, iron, steel bronze, nickel, wood, or any combination thereof. In some embodiments, the pivot member and/or receiving member can be attachable/insertable (and can be so configured) into the frame or door or other housing in a variety of ways. In some embodiments, the attachment can be a push fitting, clips, screws, or any other manner of fastening.

In some embodiments, the actuatable key can be made of, for example, plastic, nylon, rubber, metal, copper, brass, iron, steel bronze, nickel, wood, or any combination thereof. In some embodiments, the actuatable key includes one or more corners. In some embodiments, the corners are approximately ninety degrees. In some embodiments the corners are configured to meet securely with the sides of the keyhole so that the force along the direction of an open door will not inadvertently result in the removal of the actuatable key from the keyhole. In some embodiments, the corners have an angle of about 95 degrees or smaller, for example, 94, 90, 85, 80, 75, 70, 65, 60, 50, 40, 30, or 10 degrees. In some embodiments, a shape of the sides of the actuatable key complements the corresponding angle of the corner of the interior sides of the keyhole. In some embodiments, the actuatable key can be rectangular. In some embodiments, the actuatable key can be a square. In some embodiments, the actuatable key can be a triangle. In some embodiments, the actuatable key can be a circle. In some embodiments, any shape can be used as long as it can be capable of being actuated into the keyhole and removed.

In some embodiments, the actuatable key can extend substantially perpendicularly from the first or second surface when it is not actuated. In some embodiments, the actuatable key can extend substantially perpendicularly from the first or second surface when it is actuated. In some embodiments, the actuatable key can be adequately perpendicular so as to allow the actuatable key to engage the keyhole with the required force (for pivoting, although, in some embodiments part or all of this can force can also be handled by the raised disc) while also allowing the pivot member 1 to move.

In some embodiments, the pivot member 1 includes threads that can engage with threads in a housing (such as the frame or door). In some embodiments, the pivot member can be detachable from the housing. In some embodiments, the pivot member can be within the housing. In some embodiments, the pivot member can be made of, for example, plastic, nylon, rubber, metal, copper, brass, iron, steel, bronze, nickel, wood (e.g., frame or door), or any combination thereof. In some embodiments, the pivot member can be made from the wood or material of the door or frame.

In some embodiments the receiving member can be circular. In some embodiments, the receiving member can be made of, for example, plastic, nylon, rubber, metal, copper, brass, iron, bronze, nickel, wood (e.g., frame or door), or any combination thereof.

In some embodiments, the hinged-latch provides a way for allowing smooth door hinging (e.g., via the ball bearings). In some embodiments, the hinged-latch provides a way for locking the door in place once it closes, optionally automatically (e.g., key, spring and key-hole). In some embodiments, the hinged-latch provides a way for locking both sides of the door. In some embodiments, the hinged-latch provides help in locating the parts while closing and locking the hinge (e.g., shape of raised disc and slot). In some embodiments, the hinged-latch provides a way for actuating the hinges mechanically (e.g. electric solenoid).

In some embodiments, the hinged-latch allows for the hinge in each of the four corners of the door. Each hinge (while the door is closed) can be in line with the axis of rotation of the door. In some embodiments, the only thing that stops the door from opening is that the actuatable key is engaged with the key-hole, which stops the hinge/latch from opening.

In some embodiments, the hinged-latch provides for opening of the hinged-latch by pulling or pushing the actuatable key up or down into the key-hole in line with the axis of the door perpendicular to the way the hinged-latch separates.

In some embodiments, when the solenoid is triggered and the actuatable key lifts out of the key-hole, this allows the door to be opened. In some embodiments, the solenoid stays triggered until the door is closed, whereupon the solenoid engages the actuatable key 14 back in to the key-hole 4. The ramp 6 is not required in this arrangement.

In some embodiments, the solenoid can be triggered and the actuatable key 14 lifts out of the key hole 4, allowing the door to be opened. While the door is open, the solenoid is disengaged (e.g. the person opening the door lets go of the switch) and the key 14 drops back down. As the door is closed again, the key 14 slides up along the ramp 6, is located properly in the key-hole 4, and drops into the key-hole to lock the door.

In some embodiments, the key-hole 4 depth is the same as or shallower than the depth of the raised disc 3. This is to allow the ramp 6 to operate correctly. The ramp 6 can be a ramped slot that goes from the base of the raised disc 3 to the key-hole 4. It can be slightly wider at the base to allow easier self-location of the key 14.

In some embodiments, the pivot member can include the ball bearing 2 attached to it which can be located centrally around the raised disc 3 when looking from the top. The ball bearing can allow the receiving member 10 to rotate smoothly over the pivot member 1 when the two parts are aligned. In some embodiments, the bearing race can be a metal ring (e.g., of steel or titanium) with an indent to allow the ball bearing(s) to be located properly and to provide a suitable surface for the bearing.

In some embodiments, the part having the solenoid includes a cavity to house the solenoid.

In some embodiments, the receiving member 10 will bear the majority or more of the weight of the door, and will be configured and made of materials suitable for this.

In some embodiments, the default position for the actuatable key 14 in the hinged-latch is in an engaged position with the key-hole 4, to reduce the likelihood that the door will fall out.

In some embodiments, the actuatable key and/or key-hole assembly can be relatively strong. In some embodiments, this combination does not support any of the direct vertical load of the door while closed; however, when the door is open some lateral load is placed on the actuatable key, pulling it towards the opening. Most of the load is taken by the bearing, but some can still be transferred to the actuatable key. In some embodiments, the actuatable key is designed in this way, as it is used to stop the lateral movement so that the door does not ‘fall off’ the hinge.

In some embodiments, an electrical circuit can control the door as follows: 1) depressing the switch on the left side of the door would pass a signal through the hinges on the right side of the door. This would activate the solenoid on the left side of the door to unlock the left side. In some embodiments, the signal is routed through the right hinges so that the signal can be maintained even while the door is being opened and closed. In some embodiments, activating the solenoids on the left would trigger the circuit to ignore signals for the right solenoids (and vice-versa). In some embodiments, this safety mechanism stops both sides of the door from opening at once and the door coming off its hinges. As noted above, in some embodiments, this safety mechanism can be mechanical rather than electrical. In some embodiments, the actuatable key is controlled by a solenoid. When no current travels through the solenoid coil, the actuatable key 14 can extend from the receiving member 10 so that the actuatable key is in the engaged position. In some embodiments, a current passing through the solenoid can pull the actuatable key 14 up and in to the receiving member 10 (for example) so that the hinged-latch becomes unlocked. In some embodiments, the spring 30 assists moving the actuatable key into the locked position so that it can work while upside-down (the bottom two hinges). In some embodiments, the solenoid can be strong enough to counter the pushing force of the spring.

In some embodiments, the hinged-latch allows more freedom when designing interior spaces, can be simple and cheap to construct, can be suitable for kit sets and mass production, can be suitable for bespoke solutions, or for retrofitting into existing homes, can be suitable for confined spaces such as apartments (including modularly constructed housing), caravans, aircraft, trains and other vehicles, and/or can be suitable where accessibility is a problem, such as the elderly population or disabled people.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations. In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, such as in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein can be readily broken down into a lower third, middle third and upper third, etc. As will also be understood by one skilled in the art all language such as “up to,” “at least,” and the like include the number recited and refer to ranges which can be subsequently broken down into subranges as discussed above. Finally, as will be understood by one skilled in the art, a range includes each individual member. Thus, for example, a group having 1-3 cells refers to groups having 1, 2, or 3 cells. Similarly, a group having 1-5 cells refers to groups having 1, 2, 3, 4, or 5 cells, and so forth.

From the foregoing, it will be appreciated that various embodiments of the present disclosure have been described herein for purposes of illustration, and that various modifications may be made without departing from the scope and spirit of the present disclosure. Accordingly, the various embodiments disclosed herein are not intended to be limiting, with the true scope and spirit being indicated by the following claims.

The present disclosure is not to be limited in terms of the particular embodiments described in this application, which are intended as illustrations of various aspects. Many modifications and variations can be made without departing from its spirit and scope, as will be apparent to those skilled in the art. Functionally equivalent methods and apparatuses within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods, reagents, compounds, compositions or biological systems, which can, of course, vary. It is also to be understood that the terminology used herein is for the purpose of describing particular embodiments only, and is not intended to be limiting.

1. A hinged-latch, the hinged-latch comprising:
a pivot member, the pivot member comprising:
a first surface; and
a raised disc located on the first surface;
a receiving member, the receiving member comprising:
a second surface configured to meet the first surface when the pivot member and receiving member are engaged;
a pivot space, the pivot space configured to receive the raised disc and allow the raised disc to pivot within the pivot space; and
a disc-slot located within the second surface, the disc-slot configured to guide the raised disc to the pivot space;
a key-hole located in either the pivot member or the receiving member; and
an actuatable key, the actuatable key configured to engage the key-hole and allow rotation of the pivot member relative to the receiving member when engaged with the key-hole, wherein if the actuatable key is located in the pivot member then the key-hole is located in the receiving member, and wherein if the actuatable key is located in the receiving member then the key-hole is located in the pivot member.

2. The hinged-latch of claim 1, wherein the first surface comprises a low coefficient of friction surface.

3. (canceled)

4. The hinged-latch of claim 2, wherein the first surface comprises at least one ball bearing.

5. (canceled)

6. (canceled)

7. The hinged-latch of claim 1, wherein the key-hole is located in the pivot member.

8. The hinged-latch of claim 7, wherein the key-hole is located in the center of the raised disc.

9. The hinged-latch of claim 1, wherein the key-hole is located in the receiving member.

10. The hinged-latch of claim 9, wherein the key-hole is located in the center of the pivot space.

11. The hinged-latch of claim 1, wherein the actuatable key is located in the pivot member.

12. The hinged-latch of claim 11, wherein the actuatable key is located in the center of the raised disc.

13. The hinged-latch of claim 12, wherein the key-hole is located in the receiving member.

14. The hinged-latch of claim 1, wherein the actuatable key is located in the receiving member.

15. The hinged-latch of claim 14, wherein the actuatable key is located in the center of the pivot space.

16. The hinged-latch of claim 15, wherein the key-hole is located in the pivot member.

17. The hinged-latch of claim 1, wherein the actuatable key is mechanically actuatable.

18. The hinged-latch of claim 1, wherein the actuatable key is electrically actuatable.

19. The hinged-latch of claim 18, wherein the actuatable key comprises a solenoid.

20. The hinged-latch of claim 1, further comprising a spring configured to urge the actuatable key outward from the pivot member or the receiving member.

21. The hinged-latch of claim 20, wherein the spring is configured to urge the actuatable key in a first direction to a first position.

22. The hinged-latch of claim 21, wherein actuation of the actuatable key urges the actuatable key in a second direction to a second position.

23. The hinged-latch of claim 22, wherein the first direction is substantially opposite to the second direction.

24. The hinged-latch of claim 23, wherein the first position is one in which the actuatable key is engaged with the actuatable key-hole.

25. The hinged-latch of claim 24, wherein the second position is one in which the actuatable key is withdrawn from the actuatable key-hole.

26.-38. (canceled)

39. The hinged-latch of claim 1, further comprising one or more electrical tracks on a surface of the raised disc, wherein the electrical tracks are configured so as to allow current to flow when the disc is in a first orientation as well as when the disc is rotated to a second orientation.

40. A method for operating a hinged-latch, the method comprising:
providing a first hinged-latch, the hinged-latch comprising:
a pivot member, the pivot member comprising:
a first surface; and
a raised disc located on the first surface;
a receiving member, the receiving member comprising:
a second surface configured to meet the first surface when the pivot member and receiving member are engaged;
a pivot space, the pivot space configured to receive the raised disc and allow the raised disc to pivot within the pivot space; and
a disc-slot located within the second surface, the disc-slot configured to allow the raised disc to pass to the pivot space;
a key-hole located in either the pivot member or the receiving member; and
an actuatable key, the actuatable key engaged with the key-hole and configured to allow rotation of the pivot member relative to the receiving member when engaged with the key-hole, wherein if actuatable key is located in the pivot member then the key-hole is located in the receiving member, and wherein if the actuatable key is located in the receiving member then the key-hole is located in the pivot member;
actuating the actuatable key in a first direction and removing the raised disc from the pivot space;
replacing the raised disc into the pivot space; and
engaging the actuatable key with the key-hole.

41. The method for claim 40, wherein engaging the actuatable key with the key-hole comprises actuating the actuatable key in a second direction that is substantially opposite to the first direction.

42. The method for claim 40, wherein engaging the actuatable key with the key-hole comprises:
removing an electrical potential, wherein the electrical potential is a force that actuated the actuatable key in the first direction; and
providing a spring force to urge the key in a second direction, wherein the second direction is substantially opposite to the first direction.

43. A method for opening a door, the method comprising:
providing a door having at least a first hinged-latch, a second hinged-latch, a third hinged-latch, and a fourth hinged-latch, wherein the first hinged-latch is located on a top of the door and the second hinged-latch is located on a bottom of the door, substantially beneath the first hinged-latch, and wherein the third hinged-latch is located on the top of the door and the fourth hinged-latch is located on the bottom of the door, substantially beneath the third hinged-latch;
actuating a key in the first hinged-latch and withdrawing a first raised disc from a first pivot space in the first hinged-latch;
actuating a key in the second hinged-latch to withdraw a second raised disc from a second pivot space in the second hinged-latch; and
pivoting the door about a key in the third hinged-latch and a key in the fourth hinged-latch to thereby open the door.

44. The method for claim 43, further comprising:
pivoting the door about a key in the third hinged-latch and a key in the fourth hinged-latch to close the door;
engaging the key in the first hinged-latch when the first raised disc is within the first pivot space in the first hinged-latch;
engaging the key in the second hinged-latch when the second raised disc is within the second pivot space in the second hinged-latch;
actuating a key in the third hinged-latch and withdrawing a third raised disc from a third pivot space in the third hinged-latch;
actuating a key in the fourth hinged-latch and withdrawing a fourth raised disc from a fourth pivot space in the fourth hinged-latch; and
pivoting the door about a key in the first hinged-latch and a key in the second hinged-latch to thereby open the door.

45. A dual swing door comprising:
a door;
a first hinged-latch comprising a first actuatable key;
a second hinged-latch comprising a second actuatable key, wherein the first and second hinged-latches are connected to the door, and wherein the first and second hinged latches form a first pivot line about which the door can pivot;
a third hinged-latch comprising a third actuatable key; and
a fourth hinged-latch comprising a fourth actuatable key, wherein the third and fourth hinged-latches are connected to the door, and wherein the third and fourth hinged latches form a second pivot line about which the door can pivot.

46.-52. (canceled)
